(19) United States
(12) Patent Application Publication
(10) Pub. No.: US 2026/0296520 A1
(43) Pub. Date: Oct. 1, 2026

(54) Steering Wheel for a Motor Vehicle

(71) Applicant: Bayerische Motoren Werke Aktiengesellschaft, Muenchen (DE)

(72) Inventors: Christian KNOLL, Muenchen (DE); Felix LAUBER, Muenchen (DE); Frederik PLATTEN, Muenchen (DE); Andreas REITER, Grafing bei Muenchen (DE); Harald SCHLUDER, Muenchen (DE); Daniel SUSS, Muenchen (DE); Johann ZANDT, Hohenkammer (DE)

(21) Appl. No.: 18/998,173

(22) PCT Filed: Jun. 28, 2023
(86) PCT No.: PCT/EP2023/067567

§ 371 Date: Jan. 24, 2025

(30) Foreign Application Priority Data
Jul. 25, 2022 (DE) 10 2022 118 474.9

(51) Int. Cl. B62D 1/06; B60K 35/28; B60Q 3/283

(52) U.S. Cl. CPC B62D 1/046; B60K 35/28; B60K 35/60; B62D 1/06; B60K 2360/172; B60K 2360/175; B60K 2360/338; B60K 2360/782

(57) ABSTRACT

A steering wheel for a motor vehicle has a steering wheel rim, which is connected via at least one steering wheel spoke to a steering wheel hub and has, in a plane spanned by the steering wheel rim in relation to a straight-ahead position of the steering wheel, on the left and right side in each case one first portion projecting inwards to the steering wheel hub and an indentation directly thereabove, which together each form a gripping region with a thumb rest for a driver of the motor vehicle, and a lighting device, which includes at least two first and two second lighting elements and by which information can be output to the driver, where the information includes a driving state of an automatically operable motor vehicle.

### BACKGROUND AND SUMMARY

The present disclosure relates to a steering wheel for a motor vehicle.

Automated driving systems are increasingly being used in modern motor vehicles, wherein various degrees of automation are possible. The model of the German Federal Highway Research Institute (BASt), for example, distinguishes between assisted, automated and autonomous modes.

In addition, a classification into automation degrees or levels is also common. The standard applicable here is SAE J3016 from SAE International, which divides the driving functions into levels 0 to 5. Up to and including level 2, the functions assist the driver. This includes functions such as automatic parking, lane keeping, general longitudinal guidance, acceleration and braking, which are performed by assistance systems. In level 3, which corresponds to the automated mode, the vehicle can drive autonomously at times, i.e., it also performs functions such as activating the blinker, changing lanes and lane keeping independently. The driver does not have to constantly monitor the system and can temporarily tum their attention to other things, but is prompted by the system to take the lead if necessary. In Germany, the law on automated driving has already permitted the use of this technical option since 2017. From level 4, vehicles can drive independently without the driver having to be able to take over, i.e., the driving functions are autonomous when carrying out the driving task.

Automated driving is usually not possible under all road and environmental conditions. For example, a driving system for automated driving on the highway may stipulate that the vehicle can only drive automatically on certain sections of the highway that have been approved for this purpose. Before reaching the end of a section of road currently being driven on and approved for automated driving, the driver must take over all or part of the vehicle control. Current events such as an accident, a traffic jam or a person on the highway can also result in the end of the automated route. In addition, with automated driving systems, the driver usually has to take over control of the vehicle before leaving the highway for another type of road.

It is therefore necessary for the driver to take back control of the vehicle from the driving system in good time before the end of automated driving is imminent. There are various ways of prompting the driver to take over control of the vehicle, e.g., visual warnings on a display, such as a screen, acoustic or haptic warnings.

WO 2019/137699 A1, for example, discloses a steering wheel for a motor vehicle in which a light device in the form of a closed ring is inserted in the steering wheel rim on a front side facing the driver of the motor vehicle and informs the driver that the motor vehicle is in automated driving mode or in non-automated driving mode and/or that a change of driving mode is imminent.

Such a light display integrated directly into the steering wheel rim is clearly visible and has a highly inviting character for the driver, as the grip areas on the steering wheel that the driver should grasp to take control of the vehicle can be illuminated directly. However, the disadvantage of the design described is that embedding a light device in the front of the steering wheel rim makes it difficult to accommodate a steering wheel heater or a sensor system for hands-on/off detection in the steering wheel rim. Such a lighting device fully embedded in the front (and therefore also the grip area) of the steering wheel rim is also not ideal in terms of haptics, as it usually has a cover made of hard plastic.

It is therefore an object of the present disclosure to provide a steering wheel for a motor vehicle with a lighting device that is characterized by improved ergonomics and yet intuitively conveys the correct action for the driver to take over the driving task.

According to the present disclosure, a steering wheel for a motor vehicle is provided for this purpose, having a steering wheel rim which is connected to a steering wheel bub via at least one steering wheel spoke and, in a plane spanned by the steering wheel rim, has on the left-hand side and on the right-hand side, in relation to a straight-ahead position of the steering wheel, a first section projecting inwards towards the steering wheel hub and an indentation immediately above it, which together form in each case a grip region with a thumb rest for a driver of the motor vehicle, and a lighting device which comprises at least two first and two second lighting elements and with which the driver can be provided with information which characterizes a driving state of a motor vehicle which can be operated in an automated manner, wherein the projecting first sections each have an inwardly pointing free end region on which a first lighting element of the lighting device is arranged in each case, and wherein a second lighting element of the lighting device is provided in each case directly above the indentation in an inner edge region of the steering wheel rim.

Thus, in the steering wheel according to the present disclosure, the lighting device is arranged in or near the lateral grip areas, which provides a high level of prompting character when the automated driving system prompts the driver to take control of the vehicle.

As two light elements are provided on each side in the inner edge area of the steering wheel rim and the indentations that are partially gripped by the driver are left out, the light elements are not touched by the driver when gripping the steering wheel and are therefore not perceived as unpleasant to the touch.

In addition, the arrangement of the light elements in the inner edge area of the steering wheel rim makes it easier to accommodate a heating mat for a steering wheel heating system or a sensor mat for a hands-on/off detection device compared to known solutions from the prior art, as these mats are primarily arranged in the outer edge area and on the front and rear of the steering wheel rim.

The steering wheel rim does not have to be circular; preferably it has a rounded hexagonal or angular shape.

In particular, the inwardly projecting first sections are widened in relation to the basic cross-sectional thickness of the steering wheel rim outside the grip area, and the projecting first section forms a kind of “pistol grip” with the indentation on each side of the steering wheel rim, which is characterized by particularly advantageous ergonomics.

The steering wheel according to the present disclosure has at least one steering wheel spoke, which preferably connects the area of the steering wheel rim located in the lower center in the straight-ahead position (colloquially referred to as the 6 o'clock position) with the steering wheel hub. In addition, a further steering wheel spoke can be provided, which is then preferably arranged opposite (12 o'clock position), i.e., connects the area of the steering wheel rim located in the upper center with the steering wheel hub. According to the preferred design, there are no steering wheel spokes in the area of the protruding first sections (i.e. in the 3 o'clock position and 9 o'clock position), but it is conceivable in principle, for example in the form of spokes offset to the rear.

At this point, it should be noted that, for the purposes of the application, automated driving preferably takes place over a longer period of time, e.g. on the highway. In addition, this is basically to be understood as automated driving with any degree of automation, in which the driver must be able to take over the driving task completely or at least partially before an imminent end of the automated driving. In particular, the steering wheel according to the present disclosure is intended for vehicles with level 3 automation.

Preferably, in relation to the straight-ahead position of the steering wheel, the steering wheel rim has a further second section on the left and on the right above the indentations, projecting inwards towards the steering wheel hub, in the end area of which the second light element is arranged in each case.

The first and second protruding sections form a widening of the steering wheel rim on each side, which is interrupted by the indentation between them. In particular, these widenings are in the range of approximately 40° to 120° (right) and 240° to 320° (left) in the straight-ahead position, when the upper center of the steering wheel rim is designated as 0°.

Advantageously, the first and second light elements arranged on the same side in relation to the straight-ahead position of the steering wheel each lie on an imaginary line that is interrupted by the indentation, or on two imaginary lines that are parallel to each other. Such an arrangement is visually similar to the appearance of a lane boundary, which intuitively conveys to the driver the correct action for taking over the driving task.

In order to increase visibility and achieve a particularly high signaling effect, the light elements are preferably designed so that light is emitted on a front side of the steering wheel rim facing the driver, in particular with the light elements having a masking on a rear side facing away from the driver and/or on an inner circumference of the steering wheel rim.

In a development, in relation to the straight-ahead position of the steering wheel, an operating area is provided on the left and on the right side, each of which has at least one operating element, wherein the operating areas extend outwards from a steering wheel center in the plane spanned by the steering wheel rim towards the steering wheel rim, but are not connected to it and are laterally spaced from it. This results in a “free-floating” operating area on the left and right, which can be easily reached by the driver without removing their hand from the steering wheel rim.

Preferably, the operating areas have free ends pointing outwards towards the steering wheel rim, and the free end areas of the first sections projecting inwards from the steering wheel rim, on which the first light elements are arranged, lie opposite the free ends of the operating areas at least in sections and are spaced apart from them in particular. The operating areas and the inwardly projecting first sections form quasi interrupted “spokes” without a support function laterally in the 3 o'clock position and 9 o'clock position.

Preferably, the steering wheel rim has a support structure surrounded by a foam coating and a cover. The coating is in particular a leather coating, the support structure is, for example, a magnesium skeleton.

In a preferred embodiment of the present disclosure, each light element has a first assembly embedded in the foaming of the steering wheel rim and a second assembly which is inserted into the first assembly and connected to it, in particular clipped to it. This results in simple assembly and an advantageous appearance, wherein the second assembly preferably is only fitted after the coating has been applied.

A visually and haptically appealing design is achieved when the light elements are set back from the cover. In this way, the comparatively hard plastic of the light elements cannot be felt by the driver and the light elements are discreetly integrated into the steering wheel.

In a development of the present disclosure, a mat-shaped heating element and/or sensor element is provided, which is arranged under the cover at least in sections in the area of an outer circumference and/or a front side of the steering wheel rim facing the driver and is recessed at least in the areas of the light elements.

The sensor element is preferably a capacitive sensor mat of a hands-on/off detection device. In this case, the embodiment according to the present disclosure can not only reliably convey the correct action to the driver to take over the driving task, but can also detect the driver taking over the task.

Further features and advantages can be found in the following description of a preferred embodiment with reference to the accompanying drawings.

### BRIEF DESCRIPTION OF THE DRAWINGS

FIG. 1 shows a top view of a steering wheel according to various embodiments of the present disclosure;

FIG. 2 shows a top view of a steering wheel rim of the steering wheel from FIG. 1;

FIG. 3 shows a sectional view of the steering wheel rim along line A-A in FIG. 2;

FIG. 4 shows a sectional view of the steering wheel rim along line B-B in FIG. 2;

FIG. 5 shows a perspective view of the steering wheel rim from FIG. 2; and

FIG. 6 is a top view of the steering wheel rim from FIG. 2, illustrating the installation of several light elements of a light device.

### DETAILED DESCRIPTION OF THE DRAWINGS

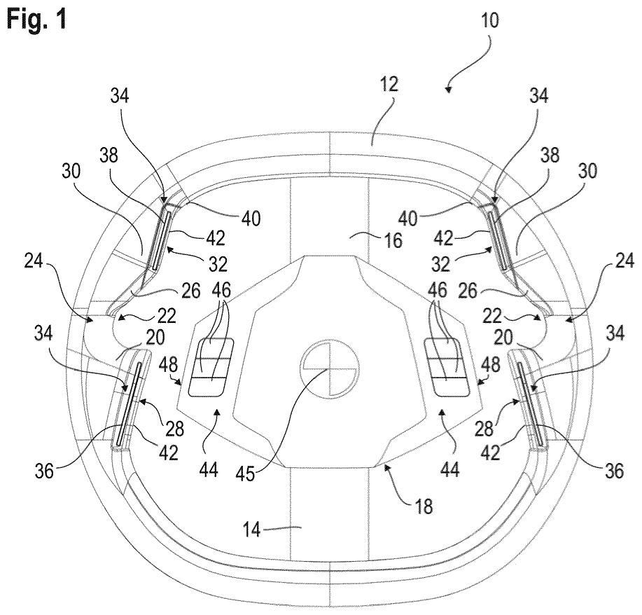

FIG. 1 shows a steering wheel 10 according to one embodiment of the present disclosure for a motor vehicle, which is used in particular in a vehicle that can be operated automatically.

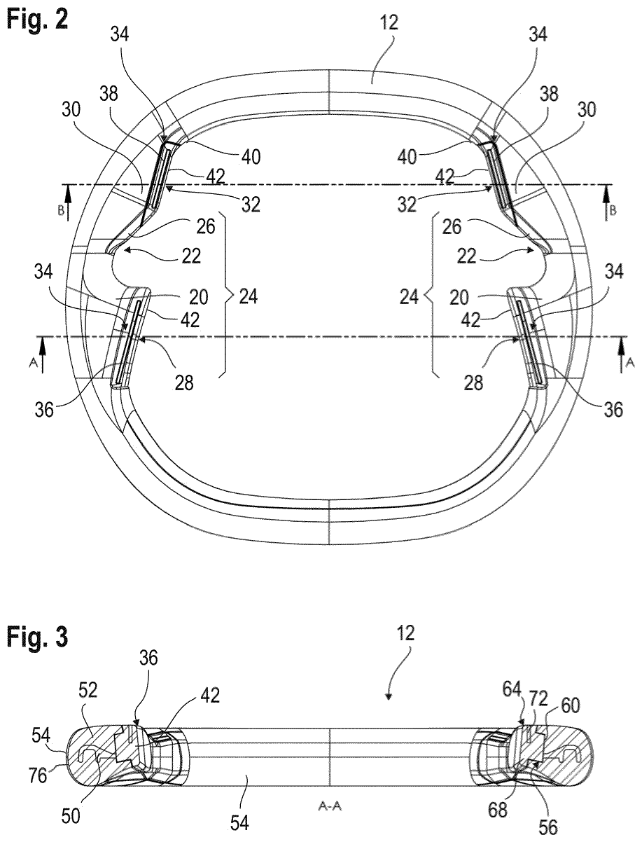

The steering wheel 10 has a steering wheel rim 12, which is shown again separately in FIGS. 2 to 5 and is connected to a steering wheel hub 18 via at least one, in this case two, steering wheel spokes 14, 16. In the straight-ahead position of the steering wheel 10 shown, the steering wheel spoke 14 extends between the area located in the lower center of the steering wheel rim 12 (colloquially referred to as the 6 o'clock position) and the steering wheel hub 18, while the steering wheel spoke 16 is arranged opposite, i.e., connects the area of the steering wheel rim 12 located in the upper center, also referred to as the 12 o'clock position, to the steering wheel hub 18.

In the plane spanned by the steering wheel rim 12, which corresponds to the drawing plane in FIG. 1, the steering wheel rim 12 has, with respect to the straight-ahead position of the steering wheel 10 shown here, a first section 20 on the left side and on the right side, which projects inwards towards the steering wheel hub 18 and is adjoined immediately above by an indentation 22. The projecting first section 20 and the adjoining indentation 22 together form a respective grip area 24 with a thumb rest 26 for a driver of the motor vehicle, wherein the grip area 24 has approximately the shape of a pistol grip.

The two inwardly projecting first sections 20 each have an inwardly pointing free end region 28.

Above the indentations 22, the steering wheel rim 12 also has a further second section 30 projecting inwards towards the steering wheel hub 18, the end region 32 of which also points towards the steering wheel hub 18 or towards the opposite side of the steering wheel 10.

The two projecting sections 20, 30 form a widening of the steering wheel rim 12 on each side of the steering wheel 10, which is interrupted by the indentation 22 located between them. In the embodiment shown, these widenings are in the range of approximately 40° to 120° (right) and 240° to 320° (left) in the straight-ahead position, when the upper center of the steering wheel rim 12 is designated as 0°.

Furthermore, the steering wheel 10 comprises a light device 34 with which information can be output to the driver which characterizes a driving state of the automatically operable motor vehicle. The light device 34 comprises two first light elements 36 and two second light elements 38, wherein the two first light elements 36 are arranged at the free end regions 28 of the inwardly projecting first sections 20.

The two second light elements 38 are each provided directly above the indentation 22 in an inner edge region 40 of the steering wheel rim 12, in this case arranged in the end region 32 of the respective projecting second section 30.

As can be seen from the figures, the steering wheel rim 12 is not circular, but substantially has a rounded hexagonal shape.

The first light element 36 arranged on the same side of the steering wheel 10 and the second light element 38 each lie on two imaginary lines parallel to each other, which are interrupted by the indentation 22. This arrangement is reminiscent of the appearance of a lane boundary, which results in a particularly high level of appeal to the driver.

The light elements 36, 38 are designed in such a way that light is emitted at least primarily on a front side of the steering wheel rim 12 facing the driver. This is achieved by the light elements 36, 38 having a masking 42 on their rear side facing away from the driver and on the inner circumference of the steering wheel rim 12 (see also FIG. 5).

As an alternative to the embodiment shown here, the light elements 36, 38 can also have a different shape or be masked in the surface not in a line form, but for example in a series of dots or the like.

Furthermore, an operating area 44 is provided on both the left and right side of the steering wheel 10 (in relation to the straight-ahead position), each of which has several operating elements 46, wherein the two operating areas 44 extend outwards from a steering wheel center 45 in the plane spanned by the steering wheel rim 12 towards the steering wheel rim 12, but are not connected to it and are laterally spaced apart from it. This results in quasi “free-floating” operating areas 44 on both sides, which can be easily reached by the driver without removing their hand from the steering wheel rim 12.

The two operating regions 44 have free ends 48 pointing outwards towards the steering wheel rim 12, wherein the free end regions 28 of the first sections 20 projecting inwards from the steering wheel rim 12, on which the first light elements 36 are arranged, are located opposite these free ends 48 of the operating regions 44 in sections, but are spaced apart from them (see FIG. 1).

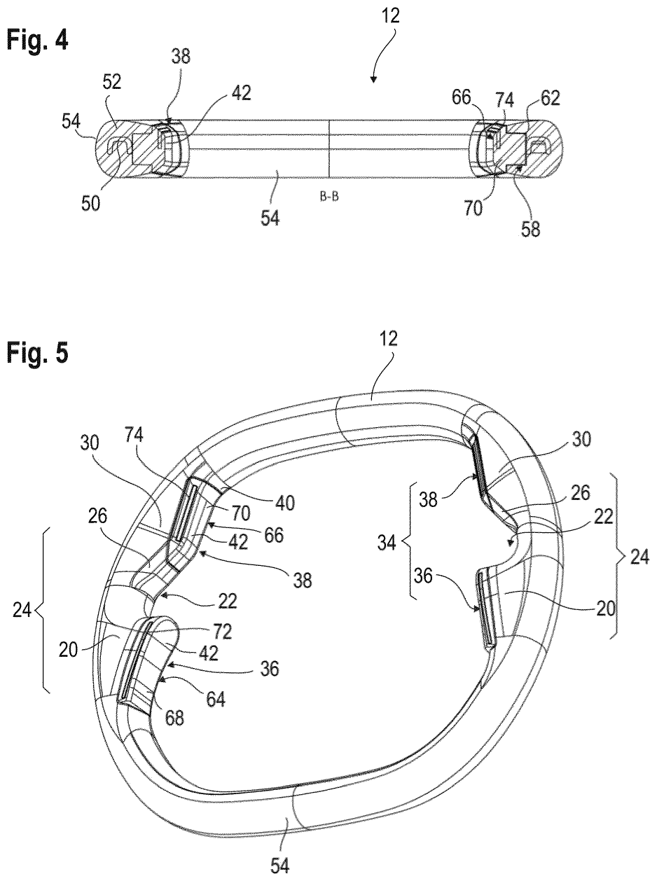

As can be seen in the sectional views of FIGS. 3 and 4, the steering wheel rim 12 of the steering wheel 10 has a support structure 50 in the form of a magnesium skeleton, which is surrounded by a foaming 52. The foaming 52 is in tum covered on the outside of the steering wheel rim 12 by a coating 54, in particular a leather covering.

Both the first light elements 36 and the second light elements 38 have a first assembly 56 or 58 embedded in the foaming 52 of the steering wheel rim 12, which in each case comprises at least one lower shell 60 or 62, which (possibly together with other components of the first assembly 56 or 58 such as a carrier board, wiring etc.) is also foamed in during the foaming of the carrier structure 50. The protruding first and second sections 20 and 30 provide sufficient installation space for this.

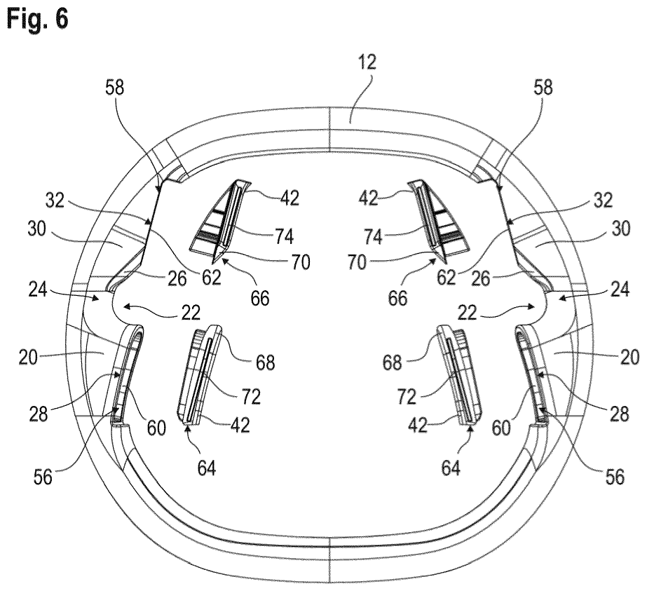

Furthermore, each of the lighting elements 36, 38 has a second assembly 64 or 66, which comprises an insert element 68 or 70 made of plastic and a light guide 72 or 74 inserted therein. The second assembly 64 or 66 is inserted into the first assembly 56 or 58 in each case after the coating 54 has been applied and is connected thereto, in particular clipped thereto, as illustrated in FIG. 6.

The light elements 36, 38 are preferably set back slightly relative to the cover 54 in the direction of the support structure 50, so that the relatively hard plastic of the light elements 36, 38 (or the insert elements 68 or 70) cannot be felt or is less felt by the driver when gripping the steering wheel 10.

Furthermore, a mat-shaped heating element and/or sensor element for hands-on/off detection can be provided, which is indicated in FIG. 3 by the reference sign 76. This is arranged in sections or along the entire steering wheel rim 12 in the region of an outer circumference and/or the front side facing the driver and/or the rear side of the steering wheel rim 12 under the cover 54 and is recessed at least in the regions of the light elements 36, 38.

1.-10. (canceled)

11. A steering wheel for a motor vehicle, comprising:
a steering wheel rim which is connected to a steering wheel hub via at least one steering wheel spoke and, in a plane spanned by the steering wheel rim, has on a left-hand side and on a right-hand side, with respect to a straight-ahead position of the steering wheel, a first section projecting inwards towards the steering wheel hub and an indentation immediately above it, which together each form a grip region with a thumb rest for a driver of a motor vehicle; and
a lighting device, which comprises at least two first light elements and at least two second light elements and with which the driver can be provided with information which includes a driving state of a motor vehicle which can be operated in an automated manner,
wherein the projecting first sections each have a free end region pointing inwards, on each of which a first light element of the light device is arranged, and
wherein a second light element of the at least two second light elements of the light device is provided directly above the indentation in an inner edge region of the steering wheel rim.

12. The steering wheel according to claim 11, wherein the steering wheel rim, with respect to the straight-ahead position of the steering wheel, has on the left-hand side and on the right-hand side above the indentation in each case a second section which projects inwards towards the steering wheel hub and in an end region of which the second light element is arranged in each case.

13. The steering wheel according to claim 11, wherein the first and second light elements arranged on a same side with respect to the straight-ahead position of the steering wheel each lie on an imaginary line which is interrupted by the indentation, or on two imaginary lines parallel to one another.

14. The steering wheel according to claim 11, wherein the first and second light elements are configured such that light is emitted on a front side of the steering wheel rim facing the driver, and wherein the first and second light elements have a masking on a rear side facing away from the driver and/or on an inner circumference of the steering wheel rim.

15. The steering wheel according to claim 11, wherein, with respect to the straight-ahead position of the steering wheel, an operating region is provided on the left-hand side and on the right-hand side, each of which has at least one operating element, wherein the operating regions extend outwards from a steering wheel center in the plane spanned by the steering wheel rim towards the steering wheel rim, but are not connected thereto and are laterally spaced apart therefrom.

16. The steering wheel according to claim 15, wherein the operating regions have free ends pointing outwards towards the steering wheel rim, and wherein the free end regions of the first sections project inwards from the steering wheel rim, on which the first light elements are arranged, lie opposite the free ends of the operating regions at least in sections and are spaced apart therefrom.

17. The steering wheel according to claim 11, wherein the steering wheel rim has a support structure, which is surrounded by a foaming, and a cover.

18. The steering wheel according to claim 17, wherein each light element of the first and second light elements has a first assembly embedded in the foaming of the steering wheel rim and a second assembly which is inserted into the first assembly and connected thereto.

19. The steering wheel according to claim 17, wherein the first and second light elements are set back relative to the cover.

20. The steering wheel according to claim 17, further comprising a mat-shaped heating element and/or sensor element, which is arranged under the cover at least in sections in a region of an outer circumference and/or a front side of the steering wheel rim facing the driver and is recessed at least in regions of the first and second light elements.
